(19) United States
(12) Patent Application Publication
(10) Pub. No.: US 2005/0022641 A1
(43) Pub. Date: Feb. 3, 2005

(54) Process for the production of a trimming strip for scoring cardboard material

(76) Inventor: Oliver Kellermann, Altdorf (DE)

Correspondence Address: Richard C. Woodbridge, Esq.;Synnestvedt Lechner & Woodbridge, LLP, P.O. Box 592, Princeton, NJ, 08542-0592, US

(21) Appl. No.: 10/899,591

(22) Filed: Jul. 27, 2004

(30) Foreign Application Priority Data
Jul. 30, 2003 (DE) 10334658.9

(51) Int. Cl. B26D 1/00

(52) U.S. Cl. 83/13; 83/879

(57) ABSTRACT

Described is a trimming strip (50) for scoring cardboard material comprising a metal strip (10) on which are fixed two base strips (18) which extend in mutually parallel relationship and between which is provided a groove channel (36). Releasably fixed on the two base strips (18) is an adjusting profile element (34) which bridges over the groove channel (36). The trimming strip (50) uses a flat-surfaced metal strip (10) which is coated over its surface area with a bonding agent (52) by means of which the two base strips (18) are fixed on the flat-surfaced metal strip (10). The base strips (18) are extruded on to the metal strip (10) which is coated with the bonding agent (52). The adjusting profile element (34) is extruded on to the two base strips (18).

The invention concerns a process for the production of a trimming strip for scoring cardboard material, wherein fixed on a metal strip are two base strips which extend in mutually parallel relationship and which define a groove channel between them, and wherein an adjusting profile element is releasably mounted on the two base strips, bridging over the groove channel.

In trimming strips of that kind, the metal strip is provided in a first step in the process with at least two mutually spaced, mutually parallel rows of perforation holes. A suitable tool is required for that purpose, and the tool needs lubrication. The perforation holes have an upwardly projecting fin or ridge extending therearound. The height of that fin has to be precisely defined. For that purpose the fins are ground away by means of a suitable grinding tool. A simpler possibility in that respect involves precisely defining the height of the fins, by means of a device referred to as a flatting device. In a subsequent step in the process the underside of the perforated metal strip is provided with a groove channel, in association with the rows of perforation holes. The groove channels are impressed into the metal strip by means of a scoring wheel. The two base strips are then extruded on to the metal strip which has been prepared in that way. In that respect, the perforation holes which have a ridge or fin extending therearound serve for mechanically anchoring the base strips on the metal strip. The extruded material of the base strips also fills the groove channels, thereby further improving the mechanical anchorage of the base strips to the metal strip. Then, the adjusting profile element which bridges over the groove channel between the base strips is extruded on to the two base strips. In that operation, the temperature of the material for the adjusting profile element upon extrusion thereof is so adjusted as to afford a defined adhesive join or adhesive force between the adjusting profile element and the two base strips.

However, the fact that the extruded material for the base strips penetrates through the perforation holes and the presence of the fin of the metal strip which surrounds the perforation holes cause an irregular flow of material during extrusion of the base strips. That irregular flow of material has an adverse influence on the quality of the surface of the base strips and on the dimensional tolerances. A further deficiency of such a known trimming strip is that the connection of the base strips to the metal strip is implemented exclusively by filling the perforation holes and the groove channels provided at the underside thereof, so that small gaps into which particles of dust can penetrate can be present between the underside of the base strips and the top side of the metal strip. Such dust particles can scarcely be avoided in particular when stamping the finished trimming strips, which are produced in an in-line procedure, to defined lengths.

DE 197 15 800 C2 to the present applicants discloses a trimming strip for scoring cardboard material, wherein two trimming material strips, that is to say base strips, are fixed on a carrier film strip by means of an adhesive, the base strips extending in mutually parallel relationship and defining a groove channel between them. An adjusting, that is to say assembly profile element, is releasably mounted on the two base strips and bridges over the two base strips.

GB 2 172 145 A describes a trimming strip for scoring cardboard packaging material comprising a metal strip, at one side of which there is provided an adhesive strip which serves for temporarily fixing the metal strip to a pressing punch. Provided at the side of the material strip, which is in opposite relationship to the adhesive layer, are two mutually spaced longitudinal strips which comprise a plastic material and which define a channel between them. The outside edges of the two mutually spaced longitudinal strips are of a bevelled or rounded configuration in order not to impede the feed of the respective cardboard packaging material to be scored.

DE 24 34 931 C2 discloses a trimming strip for scoring cardboard material, wherein an adjusting profile element is releasably mounted on a material strip of plastic material. The plastic material strip is provided with a guide groove. The adjusting profile element bridges over that guide groove. The releasable connection of the adjusting profile element to the plastic material strip is made by thermal welding.

DE 37 18 927 A1 discloses a notching matrix which has an extruded rail with a matrix portion and a support portion. The underside of the matrix portion has a layer of adhesive and a cover paper. The connection between the support portion and the matrix portion is partially severed. The underside of that known notching matrix can additionally be provided with a metal film.

The object of the invention is to provide a process of the kind set forth in the opening part of this specification for the production of a trimming strip for scoring cardboard material, wherein the trimming strip can be produced easily and in a time-saving fashion, with optimum strength and processing properties and with close dimensional tolerances.

In accordance with the invention that object is attained in that a flat-surfaced metal strip is used, that the two base strips are extruded on to the metal strip, wherein the two base strips are fixed on the flat-surfaced metal strip by means of a bonding agent provided on the metal strip over the surface thereof, and that the adjusting element is extruded on to the two base strips in such a way that the connection between the adjusting profile element and the two base strips is releasable.

In that respect it is possible to use a flat-surfaced metal strip which is pre-coated with the bonding agent. Metal strips of that kind, which are pre-coated with a bonding agent, are used for example in the automobile industry and are inexpensively available on the market.

In accordance with the invention another possibility provides that the flat-surfaced metal strip is coated in-line with the bonding agent before the two base strips are extruded in-line on to the metal strip. It has proven to be advantageous if the adjusting profile element is also extruded in-line on to the two base strips. In that respect it has proven to be advantageous if the base strips are cooled in a defined manner before the adjusting profile element is extruded on to the base strips in the in-line procedure.

Preferably PP or PVC is used for the base strips and preferably EVA is used for the adjusting profile element, wherein the temperature of the EVA upon extrusion of the adjusting profile element is set in such a way that there is a defined adhesive join between the adjusting profile element and the two base strips. To provide the defined adhesive join of the adjusting profile element to the two base strips, it is desirable if the adjusting profile element is provided on the underside with connecting ribs, in the extrusion operation.

In the process according to the invention, a double-sidedly adhesive strip is preferably fixed in-line on the underside of the metal strip. Preferably an adhesive strip with a detachable protective layer is used.

The invention has the advantages that there is no need to employ a perforating tool so that tool wear is avoided, no lubricant is necessary, there is no need for defined adjustment of the height of the ridges or fins surrounding the perforation holes, and the underside of the metal strip does not have to be provided with groove channels associated with the rows of perforation holes, but fixing over the full surface area involved is implemented between the flat-surfaced metal strip and the base strips, by means of the bonding agent, and that full-area fixing results in improved adhesive between the metal strip and the base strips. Particles of dust are prevented from passing between the top side of the metal strip and the underside of the base strips. A further advantage is that the surface of the base strips, that is to say in particular the base flanks, is flat and smooth, as a consequence of avoiding the presence of perforation holes. In addition, the uniform flow of material upon extrusion of the base strips means that it is advantageously possible to easily produce trimming strips involving small dimensional tolerances.

Further details will be apparent from the description hereinafter of process steps diagrammatically illustrated in the drawing for the production of a known trimming strip and a trimming strip diagrammatically illustrated in a sectional view and produced in accordance with the invention and diagrammatic block views for illustrating the process according to the invention for the production of such a trimming strip.

In the drawing:

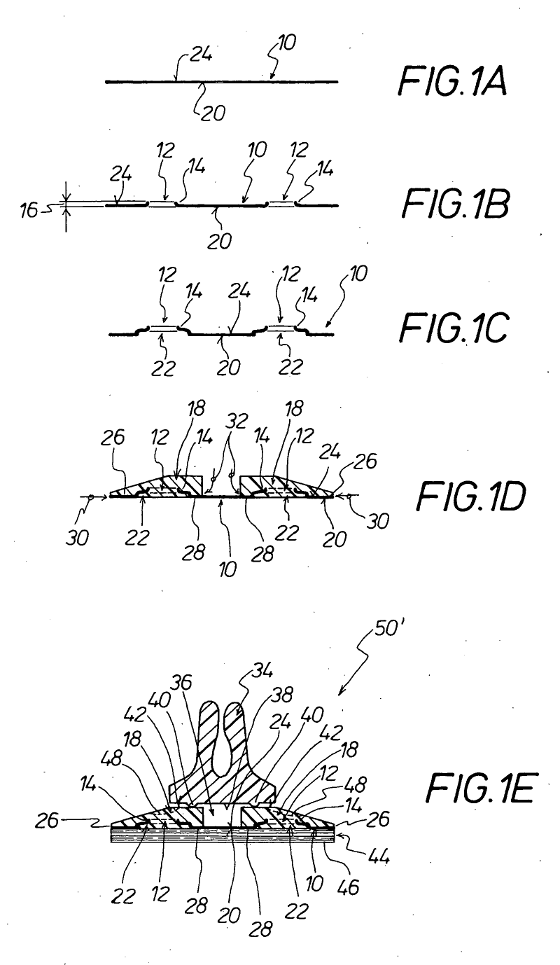

FIGS. 1A through 1E are diagrammatic enlarged views, which are not true to scale, of successive steps in a process for the production of a known trimming strip,

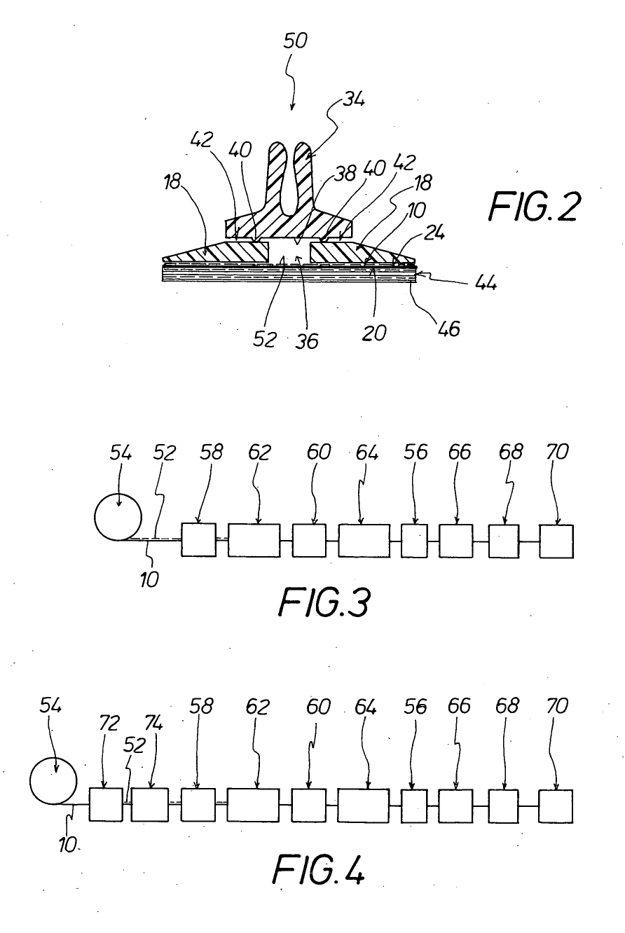

FIG. 2 is a greatly enlarged view, which is not true to scale, in section, similar to FIG. 1E, of a trimming strip according to the invention,

FIG. 3 shows a block view for diagrammatically illustrating a process according to the invention for the production of a trimming strip according to the invention as shown in FIG. 2, and

FIG. 4 is a diagrammatic block view similar to FIG. 3 of another variant of the process according to the invention.

FIG. 1A shows a metal strip 10. FIG. 1B shows the metal strip 10 which is provided with two mutually spaced, mutually parallel rows of perforation holes 12. Each perforation hole 12 has an upwardly projecting fin or ridge 14 extending therearound. The height of the fins 14 is identified by reference numeral 16. It must be defined precisely for adaptation to the heightwise dimension of the base strips 18 (see FIG. 1D).

A respective groove channel 22, as is illustrated in FIG. 1C, is provided at the underside 20 of the metal strip 10, after the formation of the perforation holes 12, in association with each of the rows of perforation holes. The base strips 18 are then extruded on the top side 24 of the metal strip 10 in mutually spaced and mutually parallel relationship (see FIG. 1D), in which case the extrusion material of the base strips 18 flows through the perforation holes 12 into the groove channels 22 and fills them up. The perforation holes 12 and the groove channels 22 provide for fixing the base strips 18 to the metal strip 10. In that situation however, it is not possible to exclude gaps 26 and 28 between the underside of the base strips 18 and the top side 24 of the metal strip 10, such gaps permitting particles of dust to pass therebeneath. That is diagrammatically indicated by the arrows 30 associated with the gaps 26 and the arrows 32 associated with the gaps 28.

In a subsequent step in the process, as shown in FIG. 1E, an adjusting profile element 34 is extruded on to the two base strips 18. The adjusting profile element 24 is connected to the base strips 18 in firmly adhering but releasable relationship and it bridges over the groove channel 36 provided between the base strips 18. To define the adhesive force of the adjusting profile element 34 on the base strips 18, the adjusting profile element 34 is provided at its underside 38 with connecting ribs 40 and the base strips 18 are provided at the top side with flat portions 42.

Fixed to the underside 20 of the metal strip 10 is an adhesive strip 44 which is double-sidedly adhesive and which is covered at its underside with a detachable protective layer 46, as is shown in FIG. 1E.

The flow of the extrusion material of the base strips 18 through the perforation holes 12 into the groove channels 22 results in an irregular flow of material which adversely affects the quality of the surface of the base strips 18. Corresponding indentations 48 are indicated in FIG. 1E by thin broken lines.

FIG. 2 is an enlarged cross-sectional view, which is not true to scale, of a trimming strip 50 according to the invention, which differs from the known trimming strip 50′ as shown in FIG. 1E in that the metal strip 10 is not formed with perforation holes 12 and groove channels 23 but is simply of a flat-surfaced nature and is covered at its top side 24 with a bonding agent 52, by means of which the base strips 18 are fixed on the flat-surfaced metal strip 10. In other respects the trimming strip 50 according to the invention as shown in FIG. 2 is of a similar configuration to the known trimming strip 50′ as shown in FIG. 1E so that there is no need, with reference to FIG. 2, to describe in detail once again all features involved, as have been described hereinbefore in connection with FIGS. 1A through 1E.

FIG. 3 is a diagrammatic block view of a process according to the invention for the production of a trimming strip 50 as shown in FIG. 2, wherein a flat-surfaced metal strip 10 is drawn off a supply roll 54 by means of a band draw-off device 56. Arranged upstream of the band draw-off device 56 are a first extruder 58 and a second extruder 60. Provided between the first and second extruders 58 and 60 is a first cooling device 62 and provided between the second extruder 60 and the band draw-off device 56 is a second cooling device 64. The metal strip 10 which is pre-coated with a bonding agent 52 is provided with a base strip 18 in firmly adhering relationship, by means of the first extruder 58. The first cooling device 62 serves to cool the extruded base strips 18. The adjusting profile element 34 is extruded on to the base strips 18 by means of the second extruder 60 and releasably connected to the base strips 18. The second cooling device 64 serves for cooling the adjusting profile element 34.

Adjoining the band draw-off device 56 is a station 66 in which an adhesive strip 44 which is adhesive at both sides and which is covered on its underside with a detachable protective layer 46 is fixed to the underside 20 of the metal strip 10. The station 66 is followed by a stamping station 68 in which the virtually endlessly produced trimming strip 50 is stamped to defined lengths. The trimming strip portions are then packaged in a packaging station 70 to be made available to users of trimming strips 50.

In comparison with FIG. 3 FIG. 4 diagrammatically shows a variant of the process, in which disposed upstream of the first extruder 58 is a station 72 in which the top side 24 of a bare metal strip 10 is coated with a bonding agent 52. The station 72 is adjoined by a drying station 74 in which the bonding agent 52 disposed on the flat-surfaced metal strip 10 is dried. In other respects the in-line production chain shown in FIG. 4 is similar to the in-line production chain shown in FIG. 3 so that there is no need for all features to be described in detail once again, with reference to FIG. 4.

Hereinbefore reference has always been made to two base strips 18. It will be appreciated however that it is also possible to provide more than two base strips 18 on the metal strip 10, by means of the bonding agent 52.

1. A process for the production of a trimming strip (50) for scoring cardboard material, wherein fixed on a metal strip (10) are two base strips (18) which extend in mutually parallel relationship and which define a groove channel (36) between them, and wherein an adjusting profile element (34) is releasably mounted on the two base strips (18), bridging over the groove channel (36),
characterised in that
a flat-surfaced metal strip (10) is used, that the two base strips (18) are extruded on to the metal strip (10), wherein the two base strips (18) are fixed on the flat-surfaced metal strip (10) by means of a bonding agent (52) provided on the metal strip (18) over the surface thereof, and that the adjusting profile element (34) is extruded on to the two base strips (18) in such a way that the connection between the adjusting profile element (34) and the two base strips (18) is releasable.

2. A process as set forth in claim 1 characterised in that a flat- surfaced metal strip (10) pre-coated with the bonding agent (52) is used.

3. A process as set forth in claim 1 characterised in that the flat- surfaced metal strip (10) is coated in-line with the bonding agent (52) before the two base strips (18) are extruded in-line on to the metal strip (10).

4. A process as set forth in claim 1 characterised in that the adjusting profile element (34) is extruded in-line on to the two base strips (18).

5. A process as set forth in claim 4 characterised in that the base strips (18) are cooled before the adjusting profile element (34) is extruded on to the base strips (18).

6. A process as set forth in claim 4 characterised in that pp or PVC is used for the base strips (18) and EVA is used for the adjusting profile element (34), wherein the temperature of the EVA upon extrusion of the adjusting profile element (34) is so set that a defined adhesive join is afforded between the adjusting profile element (34) and the two base strips (18).

7. A process as set forth in claim 6 characterised in that the adjusting profile element (34), to provide a defined adhesive join to the two base strips (18), is provided at the underside with connecting ribs (40).

8. A process as set forth in claim 2 characterised in that a double-sidedly adhesive strip (44) is fixed in-line on the underside (20) of the metal strip (10).

9. A process as set forth in claim 8 characterised in that an adhesive strip (44) having a detachable protective layer (46) is used.

10. A process as set forth in claim 5 characterised in that a double-sidedly adhesive strip (44) is fixed in-line on the underside (20) of the metal strip (10).

11. A process as set forth in claim 4 characterised in that a double-sidedly adhesive strip (44) is fixed in-line on the underside (20) of the metal strip (10).

12. A process as set forth in claim 5 characterised in that a double-sidedly adhesive strip (44) is fixed in-line on the underside (20) of the metal strip (10).

13. A process as set forth in claim 6 characterised in that a double-sidedly adhesive strip (44) is fixed in-line on the underside (20) of the metal strip (10).

14. A process as set forth in claim 7 characterised in that a double-sidedly adhesive strip (44) is fixed in-line on the underside (20) of the metal strip (10).
